(19) United States
(12) Patent Application Publication
(10) Pub. No.: US 2006/0143231 A1
(43) Pub. Date: Jun. 29, 2006

(54) Systems and methods for monitoring business processes of enterprise applications

(76) Inventors: Prashanth V. Boccasam, Bethesda, MD (US); Ajeya Tatake, McLean, VA (US); Thomas Garrity, Ashburn, VA (US); Todd Garrity, Potomac Falls, VA (US); Silas Matteson, Oakton, VA (US); Pushparaj Dhond, Burke, VA (US); Ashok Joshi, Pune (IN)

Correspondence Address: Steven P. Arnheim;Pillsbury Winthrop Shaw Pittman LLP, 1650 Tysons Blvd., McLean, VA, 22102, US

(21) Appl. No.: 11/244,060

(22) Filed: Oct. 6, 2005

Related U.S. Application Data
(60) Provisional application No. 60/702,685, filed on Jul. 27, 2005.
(60) Provisional application No. 60/616,681, filed on Oct. 8, 2004.

(51) Int. Cl. G06F 17/00; G06F 7/00

(52) U.S. Cl. 707/104.1

(57) ABSTRACT

A system and method for monitoring the business processes of an enterprise application are presented. Data relating to the business process is extracted from the enterprise application. The data is stored in a first database in a format substantially similar to a format used by the enterprise application to store the data. The data is extracted from the first database and is converted to a second format. The data is stored in the second format in a second database. A business process rule relating to the business process is created. The business process rule is converted to a query. The query is executed against the second database. A report is created and displayed based on a result of the query.

This application claims the benefit of U.S. Provisional Patent Application Ser. No. 60/702,685 filed Jul. 27, 2005 and U.S. Provisional Patent Application Ser. No. 60/616,681 filed Oct. 8, 2004, which are herein incorporated by reference in their entirety.

### BACKGROUND OF THE INVENTION

1. Field of the Invention

Embodiments of the present invention relate to systems and methods for monitoring the business processes, user privileges and configuration settings of enterprise applications. More particularly, embodiments of the present invention relate to systems and methods for continuously monitoring the user activity, transactions, and configurations of enterprise applications.

2. Background Information

Business risk is the chance of injury, damage, or loss due to a business process. A business process is a set of coordinated tasks and activities, conducted by both people and equipment, that will lead to accomplishing a specific organizational goal. Business processes include but are not limited to manufacturing, selling, purchasing, hiring, financing, and accounting. To reduce business risk, businesses establish business controls.

A business control, also known as an internal control, is a process, affected by an entity's board of directors, management and other personnel, designed to provide reasonable assurance regarding the achievement of business objectives such as effectiveness and efficiency of business operations, reliability of financial reporting, and compliance with applicable laws and regulations. For example, a business that limits the check writing authorization for a purchasing manager to $5,000 reduces or prevents the risk of significant theft by the purchasing manager during the purchasing process. Similarly, a business that establishes a procedure of reporting all cashed checks greater than $5,000 to the management team can detect significant theft in the purchasing process.

The importance of business controls has been highlighted recently by the sluggish economy, the large number of highly publicized corporate scandals, and increasing government regulations. In a sluggish economy, business controls can help reduce losses and thereby increase profits without the need for increasing revenue. Business controls can alert management, analysts, regulators, and shareholders to business problems before they turn into corporate scandals. Finally, business controls can provide the documentation and proof needed for compliance with increasing government regulations.

Business controls are particularly important in helping senior managers meet the requirements of the Sarbanes-Oxley Act of 2002. Under the Sarbanes-Oxley Act of 2002, senior managers are required to certify their responsibility for disclosure controls and procedures, produce an internal control report, provide real-time disclosures of material events, and certify the accuracy of financial statements.

Implementing and maintaining business controls across a large corporation can be a difficult task. In many large corporations, business processes are controlled by large enterprise software applications. An enterprise application is an integrated suite of software modules for business activities spanning an entire organization, including its departments and divisions. The scope of enterprise applications includes, but is not restricted to: (a) the major business applications needed to operate a business such as manufacturing, sales order processing, procurement processing, inventory management, human capital management, financial accounting and treasury (b) management of the enterprise application to govern security and access rights for employees or business partners of the organization to the applications functions and data, management of the data and information, management of the operations of the application for performance, tuning, capacity planning, reporting and logging. As a result, implementing business controls in many large corporations involves controlling or monitoring enterprise applications. Exemplary enterprise applications include but are not limited to enterprise resource planning (ERP), supply chain management (SCM), and customer relationship management (CRM) programs. Exemplary vendors of enterprise applications include but are not limited to Oracle®, PeopleSoft® (now part of Oracle®, Siebel®, and SAP®.

The business risk associated with an enterprise application is directly related to its size, complexity, and cost. Outside consultants, with experience and expertise in the enterprise application, are often employed to assist in the various phases of planning, selecting, training, customizing, and implementing an enterprise application. During the implementation, the abundant application level controls are often turned off to facilitate development, testing, and demonstrations for upper management. In this respect, an enterprise application can be thought of as a large office building containing many offices, doors, and filing cabinets. Rather than locking of all the doors and filing cabinets during the implementation, it is often easier to keep everything opened and unlocked. Once the modules and processes are operating correctly, the doors can be closed and locked, and the keys given to the appropriate people who need access.

Unfortunately, what happens all too frequently is not all of the doors are closed, not all of the doors are locked, and too many people have the keys. In other words, the application controls are left open or improperly set up. This vulnerability often gets explained away due to deadlines, cost or time over-runs. In other cases, a lack of familiarity with the new system can leave businesses unsure as to what doors to close and lock, so these businesses error on the side of facilitating business processes rather than inhibiting business processes.

It is also not uncommon for administrators to leave back doors open in order to rapidly resolve problems, especially in a business crisis. In other cases, the initial implementation may have been correct, but due to reasons such as a merger, acquisition, corporate reorganization, or a competitive marketplace, the internal controls subsequently need to be adjusted to adequately reflect the new business conditions. The net result is that many application level controls are not properly set and management lacks visibility as to what controls are really in place. As large corporations implement additional enterprise application modules, integrate disparate best-of-breed applications, or shift to more online services, the problems of properly instrumented controls within the individual applications that make up their business backbone are even more difficult to detect and correct.

It is common for people associated with an organization, e.g., employees or business partners such as vendors and customers, to experience change in their roles and responsibilities. Administrators may respond by delegating additional access rights required for the new responsibilities. All too often, however, the important step of revoking older, irrelevant authorizations is missed, resulting in the uncontrolled growth of authorizations many of which may have become unnecessary.

In view of the foregoing, it can be appreciated that a substantial need exists for systems and methods that can advantageously monitor the business processes of enterprise applications.

### BRIEF SUMMARY OF THE INVENTION

One embodiment of the present invention is a system for monitoring a business process of an enterprise application. The system includes an adapter component, an adapter database, a core service component, a core services database, and a user interface. The adapter component extracts data relating to the business process from the enterprise application. The adapter component stores the data in the adapter database in a format substantially similar to a format used by the enterprise application to store the data. The core services component communicates with the adapter component, schedules data extraction by the adapter component from the enterprise application, and receives the data in a second format from the adapter component. The data received by the core services component from the adapter component is extracted from the adapter database by the adapter component and converted to the second format by the core services component. The core services component stores the data in the core services database. The core services component creates a business process rule relating to the business process, executes the business process rule against the core services database, and creates a report based on the result of the execution. In executing the business process rule against the core services database, the core services component converts the business process rule to a query and executes the query against the core services database. Alternatively, the core services component executes specific algorithms against the core services database to detect violations of a business control. The user interface allows a user to control creation of the business process rule by the core services component and allows a user to monitor the business process by displaying the report created by the core services component.

Another embodiment of the present invention is a method for monitoring the business processes of enterprise applications. Data relating to the business process is extracted from the enterprise application. The data is stored in a first database in a format substantially similar to a format used by the enterprise application to store the data. The data is extracted from the first database and is converted to a second format. The data is stored in the second format in a second database. A business process rule relating to the business process is created. The business process rule is converted to a query. The query is executed against the second database. A report is created and displayed based on a result of the query.

Another embodiment of the present invention is a method for monitoring user activity of enterprise applications. A first user, a first user role, and a first user permission are extracted from a first enterprise application. The first user, the first user role, and the first user permission are stored in a first database in a format substantially similar to a format used by the first enterprise application to store the data. The first user, the first user role, and the first user permission are extracted from the first database. The first user role is mapped to a first functional role and the first user permission is mapped to a first effective right. The first user, a first role mapping to the first functional role, and a first effective right mapping to the first effective right are stored to a second database. A business process rule is created relating the first functional role and the first effective right. The business process rule is converted to a query. The query is executed against the second database. A report is created and displayed based on a result of the query.

Another embodiment of the present invention is a method for monitoring business transactions of enterprise applications. Business transaction data is extracted from an enterprise application. The business transaction data is stored in a first database in a format substantially similar to a format used by the enterprise application to store the data. The business transaction data is extracted from the first database. The business transaction data is converted to a second format. The business transaction data is stored in the second format to a second database. A business process rule is created relating to the business transaction. The business process rule is converted to a query. The query is executed against the second database. A report is created and displayed based on a result of the query.

Another embodiment of the present invention is a method for detecting false positives when monitoring a first business process and a second business process of an enterprise application. First business process data and second business process data are extracted from the enterprise application. The first business process data and the second business process data are stored in a first database in a format substantially similar to a format used by the enterprise application to store the data. The first business process data and the second business process data are extracted from the first database. The first business process data and the second business process data are converted to a second format. The first business process data and the second business process data in the second format are stored to a second database. A business process rule is created relating to the first business process data. The business process rule is converted to a query. The query is executed against the second database. If the query results in a violation of the business process rule, the violation is compared to the second business process data. If the comparison of the violation and the second business process data shows that the violation is not a business process problem, the violation is not reported.

### BRIEF DESCRIPTION OF THE DRAWINGS

FIG. 1 is a schematic diagram showing an exemplary system for monitoring the business processes of enterprise applications, in accordance with an embodiment of the present invention.

FIG. 2 is a schematic diagram showing exemplary interconnections of major components in a system for monitoring the business processes of enterprise applications, in accordance with an embodiment of the present invention.

FIG. 3 is an exemplary display of information provided by a user interface of a system for monitoring the business processes of enterprise applications, in accordance with an embodiment of the present invention.

FIG. 4 is a schematic diagram of exemplary services provided by a core services component of a system for monitoring the business processes of enterprise applications, in accordance with an embodiment of the present invention.

FIG. 5 is an exemplary display of business rule information for accounts payable business processes from a system for monitoring the business processes of enterprise applications, in accordance with an embodiment of the present invention.

FIG. 6 is an exemplary display of predefined options that can be used when creating and modifying a business rule in a system for monitoring the business processes of enterprise applications, in accordance with an embodiment of the present invention.

FIG. 7 is an exemplary display of a report from a system for monitoring the business processes of enterprise applications, in accordance with an embodiment of the present invention.

FIG. 8 is a flowchart showing a method for monitoring the business processes of enterprise applications, in accordance with an embodiment of the present invention.

FIG. 9 is a flowchart showing a method for monitoring user activity of enterprise applications, in accordance with an embodiment of the present invention.

FIG. 10 is a flowchart showing a method for monitoring business transactions of enterprise applications, in accordance with an embodiment of the present invention.

FIG. 11 is a flowchart showing a method for detecting false positives when monitoring a first business process and a second business process of an enterprise application, in accordance with an embodiment of the present invention.

Before one or more embodiments of the invention are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

Historically, detecting and correcting problems within business processes has been done through sporadic spot checks including user profile analysis, internal and external audits, and data mining. These spot checks resulted in problems that often went undetected for long periods of time until a periodic audit or a random sequence of events led to the discovery. Traditionally, businesses have addressed the problem by adding staff and developing simple in-house tools focused around data extraction and analysis.

Recognizing automation and integration advances in enterprise applications, the present invention provides new approaches for ensuring business processes are operating correctly. One embodiment of the present invention is a continuous and exhaustive (rather than spot) monitoring approach. A continuous monitoring approach allows for ongoing review of business controls and transactions watching for conflicts, anomalies, violations, and exceptions. If a potential problem is detected, the continuous monitoring solution can notify the appropriate individuals for further investigation and correction if needed. The result is a more timely approach to detection and correction of specific transactions and processes that fall outside a business' predefined criteria for acceptability. Continuous monitoring enables businesses to reduce and manage exposure to risk, increased costs, or potential revenue loss. Continuous monitoring provides greater visibility into the critical business processes and transactions that directly impact regulatory compliance, cost containment policies, revenue recognition, and policy requirements. The exhaustive nature of the continuous monitoring approach ensures that conflicts, anomalies, violations and exceptions do not go undetected, as can happen in the case of spot monitoring.

The continuous monitoring approach provides business managers, auditors, security professionals, and senior executives with visibility into user activity within business transactions and processes to detect conflicts, anomalies, violations, and exceptions. The value of this approach is in detecting these conditions as they occur, enabling them to be addressed immediately, rather than learning about them weeks, months or longer after the fact, when it may be too late.

Business managers inherently understand their jobs and how their business operates, no matter if they are a financial controller, plant manager, sales manager, or purchasing manager. Successful managers set goals, monitor the progress, and make adjustments as needed to stay on course. The enterprise applications that form the backbone of business processing present a challenge to business managers, however. Business managers must learn and understand these enterprise applications in order to effectively monitor progress, look for exceptions, and take corrective actions.

Another embodiment of the present invention is a system that continuously and exhaustively monitors the transactions of enterprise applications and alerts business managers to potential conflicts and problems without requiring a specialized knowledge of the enterprise applications. This system does not require that business managers learn and understand the details of each enterprise application. Instead, this system contains a rules engine that allows business managers to describe business controls in simple and descriptive language. The system then converts this language into a specific query or parameters for an algorithm for the particular enterprise application performing the targeted business process. This system enables business managers to monitor the user activity, transactions, and configurations of enterprise applications.

User Activity

Before business transactions can be monitored, it is important to understand who is authorized to perform operations and transactions in enterprise applications. Enterprise applications including but not limited to those from Oracle®, PeopleSoft®, Siebel®, and SAP® offer a wealth of internal security mechanisms to control and limit what authorized users can do within the application. For example, amount, frequency, and vendor can limit the goods and services a purchasing agent can order. The majority of enterprise applications take advantage of role-based access controls as a means for managing complex problems. However, the security models used by each enterprise application are different. As a result, it is difficult to maintain the same level of security across multiple enterprise applications, although this continuity is often required. For example, a regional sales manager can have access rights to a CRM application and an ERP application at the same time.

To monitor user activity within enterprise applications, organizations need the ability to abstract role-based controls and permissions from the individual application level to a more easily managed business or functional level. Thus, a functional role can be established for a business manager that can contain the appropriate levels of access within each enterprise application that the business manager needs to perform his job. The functional role can map to the specific enterprise application roles and controls to properly instrument the application access for the business manager. The objective of the abstracted functional role is not to replace the security within the individual application, nor is it to do away with the need for application administrators. Instead, the abstracted functional role greatly simplifies the process and management of ensuring that users have the proper access across ERPs and ERP instances, and enables fast, easy detection of conflicts resulting from too much authority.

In another embodiment of the present invention, security and profile information is extracted from each enterprise application. Security and profile information is also called user role information. The extracted individual and group data is mapped to a user profile making it easy to view the applications each user can access, the roles each user has been assigned in each enterprise application, and the specific authorization values or permissions each user has within each enterprise application. The abstracted security data is also mapped to a generic security model that enables roles and access rights to be easily managed across multiple applications, eliminating the need for managers, auditors, and help desk personnel to become experts in different enterprise applications.

The generic security model includes functional roles. Functional roles are made up of one or more enterprise application roles from one or more enterprise applications. Thus, individual roles from enterprise applications including but not limited to those from Oracle®, PeopleSoft®, Siebel®, and SAP® can be combined into a functional role for easier assignment, removal and monitoring. Assigning a functional role to a user's profile results in the user obtaining the appropriate individual roles and permissions in each of the specified enterprise applications.

As a result of functional roles, application users' effective rights can be calculated not only within a single enterprise application but also across a number of applications. This information allows auditors and business managers to quickly and easily answer questions concerning access to enterprise applications as well as specific operations that can be performed.

In addition, auditors and business managers can monitor for separation of duty conflicts that arise as a result of assignment of too much authority within and across enterprise applications. When security information is extracted from an enterprise application, this information is compared to role management rules to determine if any separation of duty conflicts exists or if other management role violations have occurred.

Further, to help minimize the number of new separation of duty conflicts, an automated request and approval process is provided that pre-analyzes application access requests to determine if the requests, if approved, would result in any role management violations. If there is a conflict, several alternatives for managing the conflict are presented. In some instances, a conflict cannot be allowed under any circumstances and the request is rejected accordingly. In other situations, a conflict can be tolerated, if proper justification can be provided and if specific compensating controls are adhered to. The methodology for documenting reasons to override a separation of duty conflict is provided as well as instructions for compensating controls that will need to be followed. This enables employees and business managers to have clear instructions and guidelines for proceeding. It also provides valuable documentation on the reasons for why the assignment was made and how the company is mitigating the risks this conflict could present. This documentation can be used for internal and external audits to prevent additional problems and concerns.

Transactions

An effective management strategy for complex business operations is management by exception. Business process owners know what to look for. Business process owners know what metrics are important to keep track of in order to know if the business process they manage is operating at an effective and efficient level. What business process owners need is a way to get more visibility into the business transactions and to filter them for the exceptions. A business transaction is essentially an instance of a business process. It is an atomic sequence of activities that create, modify, or delete business data. Examples of business transactions include purchases, sales, movements of goods, acceptance or rejection of goods, transforming one set of components into another finished or semi finished product (manufacturing), creation/deletion/modification of business entities such as users, vendors, customers, material. In another embodiment of the present invention, business transaction information is extracted from each enterprise application, providing the ability to detect exceptions and notify the business manager or auditor when an exception or violation has occurred. With the present invention, auditors need not dig through data extracts and business managers need not comb through transaction detail reports.

Business process owners and auditors can provide instructions to monitor for specific transactions or to watch for specific situations that represent an exception, violation, or anomaly. Exemplary instructions provided by business process owners and auditors include monitoring and alerting after the execution of any sensitive transaction, including financial, procurement, order entry, or supply chain; monitoring for the execution of sensitive transactions by individuals outside a specific department or location or time frame such as after hours or on weekends; monitoring for trends on sensitive transactions such as the number of new vendor accounts created within a given time frame or checks cut or employees hired or discounts given; and monitoring for exception conditions around transactions such as pricing discounts, purchase orders, shipments received, and product returns. By continuously monitoring business transactions, the business managers, auditors, security professionals, and senior management gain greater visibility into their business controls, which enables improvements in efficiency and reductions in risks.

Configurations

Oracle®, PeopleSoft®, Siebel®, and SAP® enterprise applications all offer a wealth of internal controls or configurations governing how the application is used, by whom it is used, and how to protect the underlying information. These internal control settings are not always set up properly. In addition, business conditions can change, dictating the need to change the controls. Either way, business managers, auditors, and security professionals need an easier way to determine what controls are in place to ensure proper usage of the applications. In another embodiment of the present invention, configuration information is extracted from each enterprise application. Configuration information tells business managers and auditors what each enterprise application is allowed to do.

User Activity, Transactions, and Configurations

Separate review of the user activity, transactions, and configurations of enterprise applications can result in “false positives.” A false positive is the false assertion of a business control violation. This usually happens because not all business settings have been taken into account when evaluating the control. An apparent segregation of duty conflict may, in fact, be non-existent because of some overriding setting at the highest enterprise application level. For example, a non-manager employee may have been given supervisory access to the human resources (HR) portion of an enterprise application. An auditing tool that only looks at user activity would report this as a rule violation. However, if the enterprise application is configured so that the HR portion is disabled, this rule violation has no impact on the business process. Consequently, the rule violation would be a false positive. This false positive, however, cannot be uncovered simply by monitoring the user activity of the enterprise application. The configuration of the enterprise application also must be monitored and any rules violations from monitoring user activity must be compared with the configurations of the enterprise applications.

In another embodiment of the present invention, user security and profile information, transactions information, and configuration information are extracted from each enterprise application. The user security and profile information, transactions information, and configuration information are compared with user security and profile rules, transactions rules, and configuration rules, respectively. Each rule violation is then compared with the information extracted from the two other areas. This comparison determines whether the rules violation is an actual business process problem or a false positive.

Systems and Methods

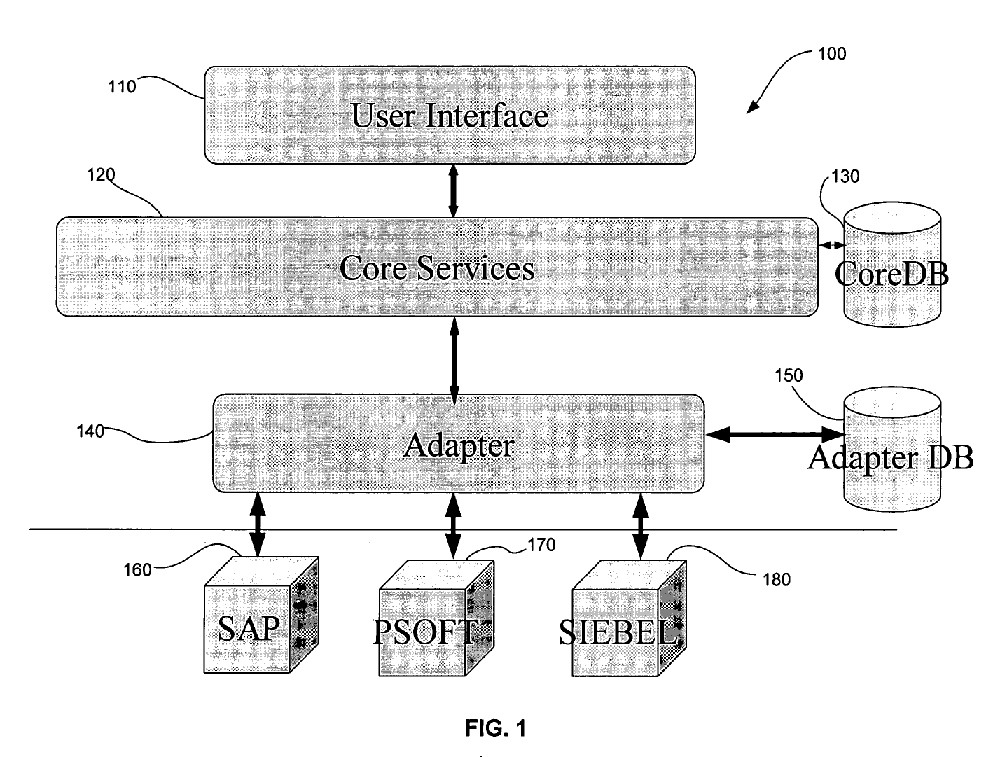

FIG. 1 is a schematic diagram showing an exemplary system 100 for monitoring the business processes of enterprise applications, in accordance with an embodiment of the present invention. System 100 monitors the business processes of an enterprise application by extracting data from that application in the format of the application, converting the extracted data to the format of system 100's database, running queries on that data in system 100's database that are generated from business process rules, and providing reports based on those queries. The database of system 100 contains an application-independent data format. This application-independent format allows system 100 to monitor the business processes of one or more enterprise applications with little modification.

System 100 includes user interface 110, core services 120, core services database 130, adapter 140, and adapter database 150. Adapter 140 periodically extracts the data from an enterprise application. Exemplary enterprise applications 160, 170, and 180 are shown in FIG. 1 as SAP®, PeopleSoft®, and Siebel®, respectively. Adapter 140 extracts data from SAP® enterprise application 160, for example. Adapter 140 places this extracted data in adapter database 150 in the format of SAP® enterprise application 160. Core services 120 periodically connects to adapter 140 to obtain the data stored in adapter database 150. Adapter 140 converts the data to the format of core services database 130. Core services 120 receives the data in the format of core services database 130 from adapter 140 and stores the data in core services database 130. Core services database 130 and adapter database 150 are logically separate databases, in order to separate application specific and application independent data. One skilled in the art will appreciate, however, that core services database 130 and adapter database 150 can physically be the same database. One skilled in the art will also appreciate that the data format of core services database 130 can be substantially similar to the data format of one enterprise application. In other words, system 100 can use a data format substantially similar to one enterprise application and convert the data of all other enterprise application to that data format.

Using core services 120, users create business process rules. Business rules are implementations of business controls. Core services 120 converts these business process rules to queries or parameters for rule specific algorithms and executes these queries against core services database 130 or executes these algorithms. Results from these executions that violate business rules are called violations. Violations are also stored in core services database 130. In addition to creating business rules and executing queries or algorithms against core services database 130, core services 120 provides reports to users. Core services 120 obtains the data for these reports from the data stored in core services database 130. This data includes the violations stored from queries. Users interact with core services 120 using user interface 110. User interface 110 allows users to configure system 100, create business process rules, and view reports.

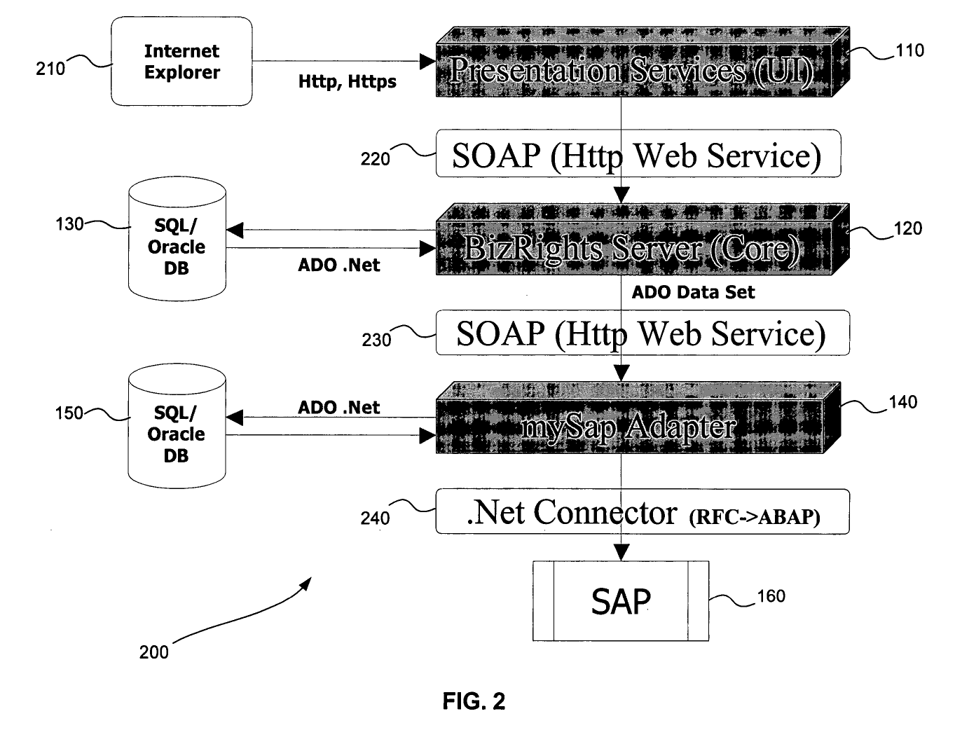

FIG. 2 is a schematic diagram showing exemplary interconnections of the major components in an exemplary system 200 for monitoring the business processes of enterprise applications, in accordance with an embodiment of the present invention. In system 200, user interface 110 is a Web server. A user can access user interface 110 using Web browser 210. Connection 220 between user interface 110 and core services 120 is made using a SOAP Web service. Core services 120 accesses core services database 130 using Microsoft® ActiveX® Data Objects. Connection 230 between core services 120 and adapter 140 is also made using a SOAP Web service. Adapter 140 accesses adapter database 150 using Microsoft® ActiveX® Data Objects. The connection between adapter 140 and an enterprise application is specific to the enterprise application. For example, connection 240 between adapter 140 and SAP® enterprise application 160 is made using SAP®. Net Connector.

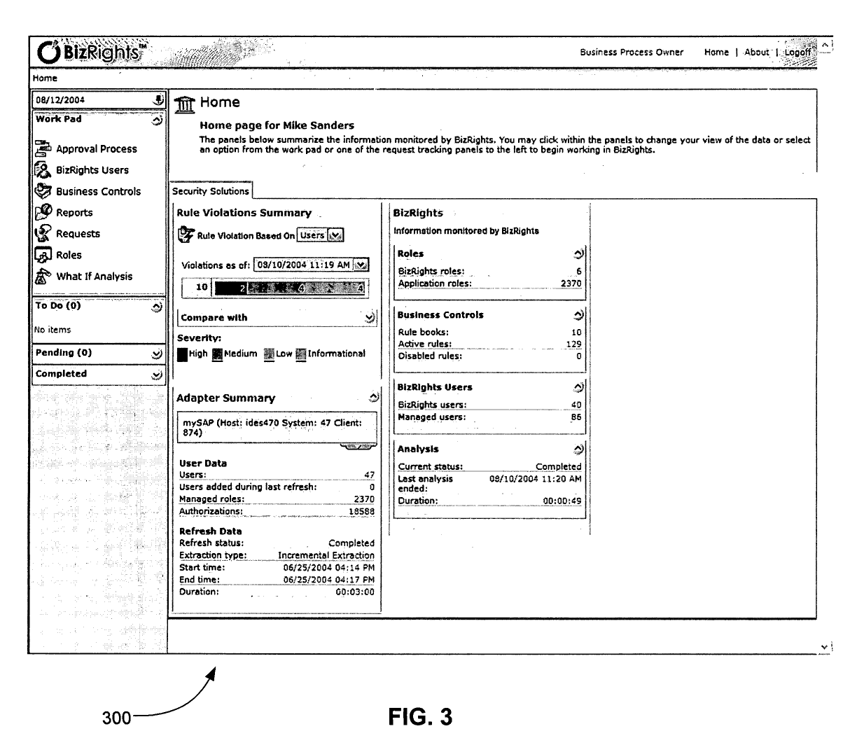

User interface 110 allows users to create and review reports, receive and act on alerts, approve or disapprove requests, provide access to other users, create and test rules or business controls, view, create or edit business entities such as users, roles, authorizations, perform ‘what if’ analysis (“will there be new violations if I assign these roles to these users?”), view and act on exceptions and violations, and configure system 100. FIG. 3 is an exemplary display 300 of information provided by user interface 110 of system 100, in accordance with an embodiment of the present invention.

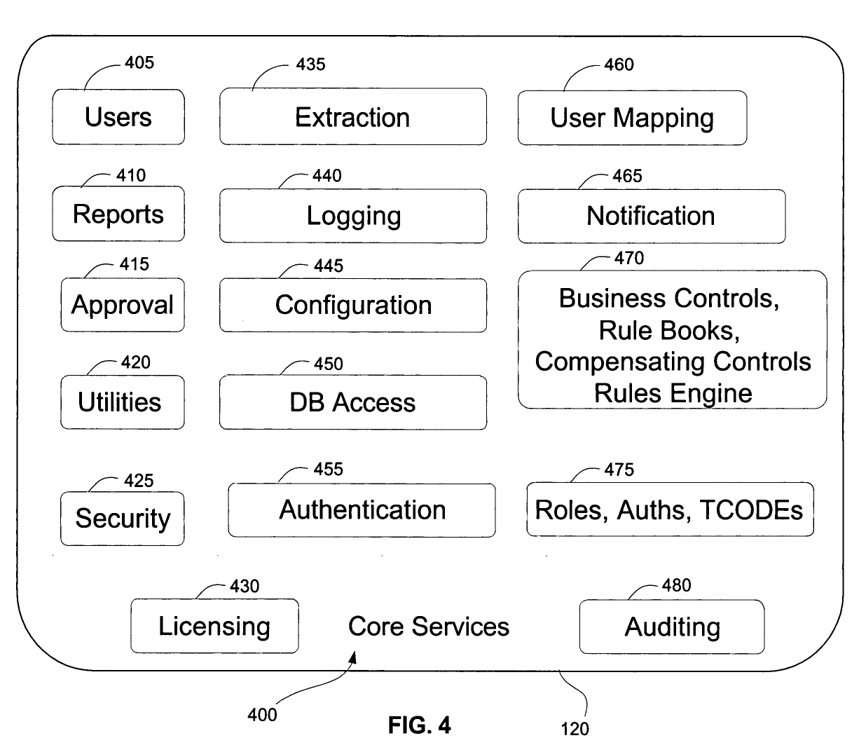

FIG. 4 is a schematic diagram of exemplary services 400 provided by core services component 120 of system 100, in accordance with an embodiment of the present invention. Exemplary services 400 include users 405, reports 410, approval 415, utilities 420, security 425, licensing 430, extraction 435, logging 440, configuration 445, database access 450, authentication 455, user mapping 460, notification 465, rules engine 470, roles 475, and auditing 480.

Authentication service 455 limits the access of users to system 100. Authentication is preferably established with a username and password. The invention can also support integration with external authentication services such as Lightweight Directory Access Protocols (LDAP) and Single SignOn (SSO) providers.

Approval service 415 uses workflow routing and provides a process for obtaining approvals from users before sending a request change to an enterprise application administrator. System 100 can determine a business process violation in an enterprise application. To remedy the violation, a request can be made through system 100 to the violating enterprise application. Before such a request is made, however, approval service 425 ensures that the correct user or users have been notified and approve of the request.

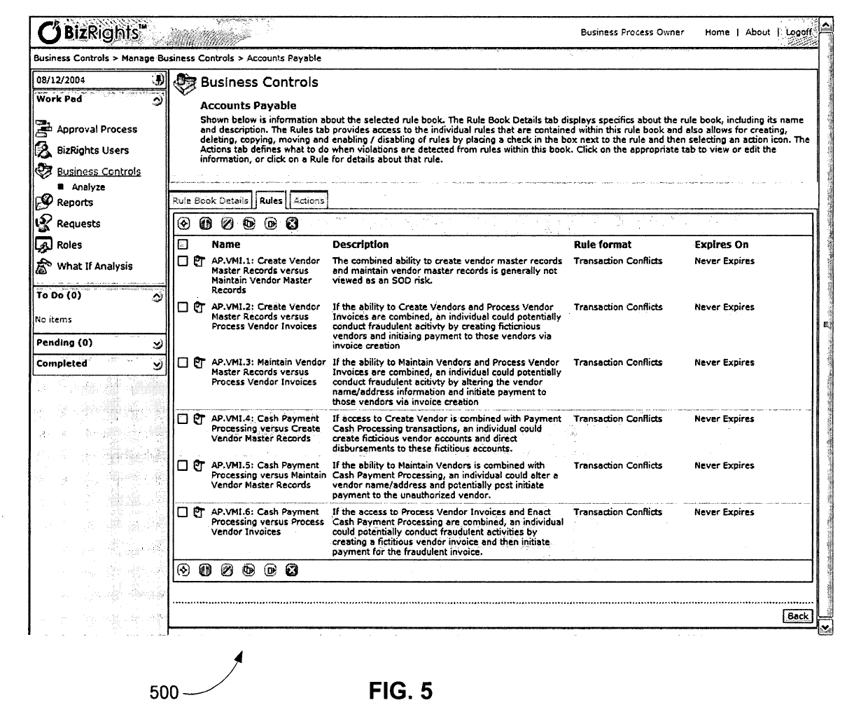

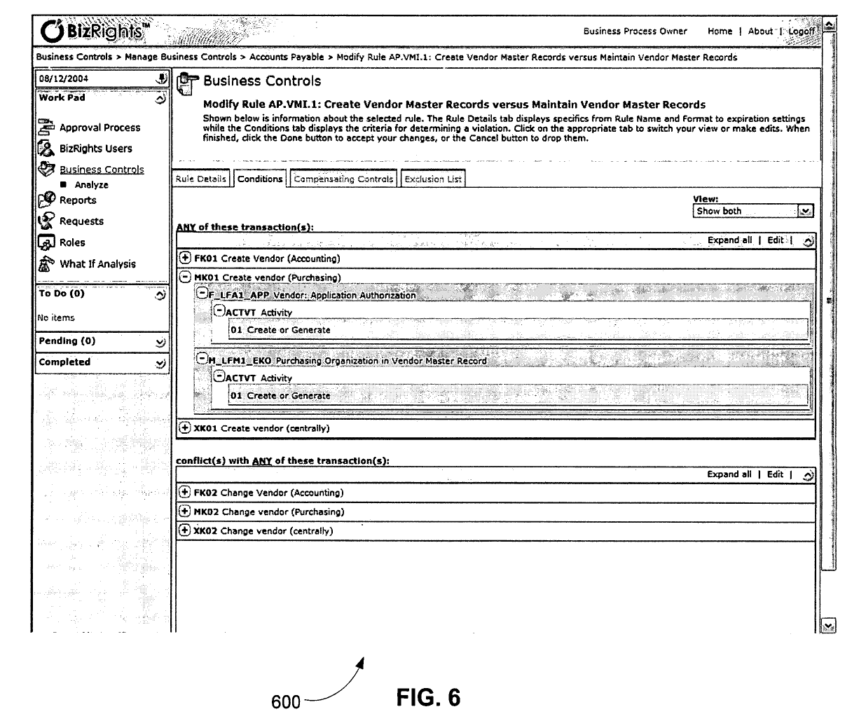

Rules engine service 470 allows users to create, modify, and execute business rules used to monitor business processes in enterprise applications. FIG. 5 is an exemplary display 500 of rules information for accounts payable business processes from system 100, in accordance with an embodiment of the present invention. This display 500 of rules information includes a business process rule that looks for users of an enterprise application who can both create and maintain vendor master records. Users that can both create and maintain vendor master records can represent a risk for some businesses. Rules engine service 470 allows users to create and modify rules by selecting from predefined rule options. FIG. 6 is an exemplary display of predefined options 600 that can be used when creating and modifying a business rule in system 100, in accordance with an embodiment of the present invention. The display 600 of predefined options shows that a purchasing user has the ability to create or generate a vendor master record.

Rules engine service 470 translates the options selected by a user in creating or modifying a business process rule into a query. Rules engine service 470 executes the query it creates from the business process rule and executes it on the core services database 130. Results from this query represent a potential violation of a business process. These results, or violations, are stored in core services database 130. These results are also sent to reports service 410 for presentation to a user. One skilled in the art would appreciate that rules engine service 470 can convert a business process rule into a structured query language (SQL) query for execution on a relational core services database 130.

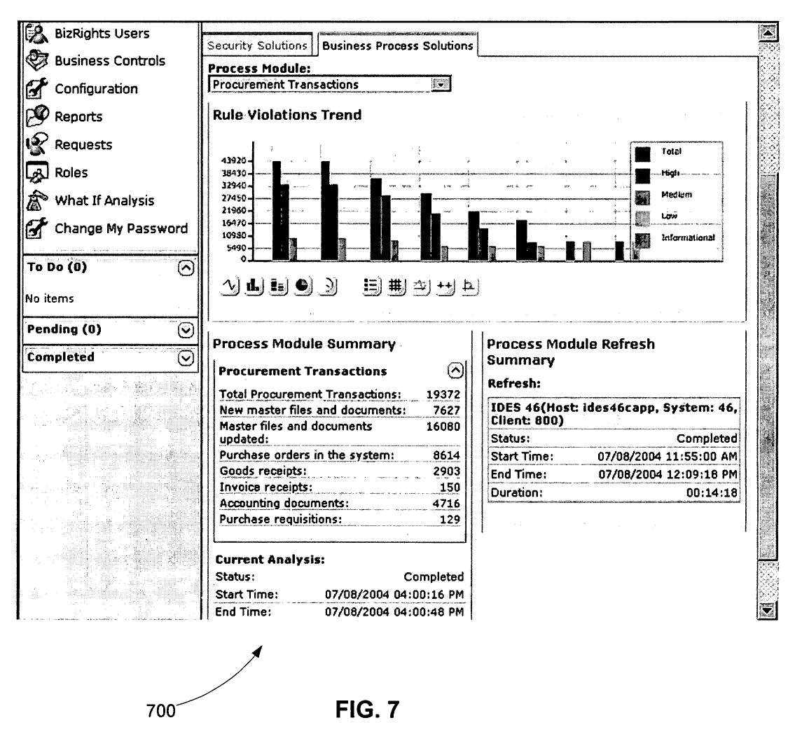

Reports service 410 provides a list of available reports, executes a query on core services database 130 for a selected report, and formats the results for display to the user. Reports are stored in core services database 130. Each report consists of a query that can be executed on core services database 130. A user is provided with a list of available reports. When a user selects a report for viewing, the query of that report is executed on core services database 130. Results from the query are analyzed and can be displayed graphically. FIG. 7 is an exemplary display 700 of a report from system 100, in accordance with an embodiment of the present invention. The display 700 of a report shows different types of rules violations plotted graphically over time. In one embodiment of the present invention, reports service 410 utilizes Microsoft® SQL Sever Reporting Services (MSSSRS) to issue the query to core services database 130 and to graphically render the results.

Users service 405 provides functionality for creating, editing, deleting users within enterprise application and their attributes.

Utilities service 420 provides services to other modules for such operations as compressing and decompressing information in files and in memory.

Security service 425 ensures that users making requests for viewing and editing information, changes in authorizations, creating and executing reports have appropriate authorizations.

Licensing service 430 verifies that adequate licenses have been procured for the legal deployment of the invention

Extraction service 435 leverages the functionality of Adapter 140 to extract security and process information from enterprise application 160 and then persists it in adapter database 150.

Logging service 440 allows other modules to log key events during extraction, analysis, and reporting. Information is persisted in special log files as well as logging facilities provided by the underlying operating system. This information is analyzed in the event of unforeseen failures.

Configuration service 445 allows the configuration of certain global settings and controls such as connection formats specific to enterprise applications, notification service settings, schedules for extraction and analysis, credentials to be used when communicating with database servers and enterprise applications.

Database access service 450 provides a portable layer to other modules so that they can communicate with physical databases in a generic way, without knowing specific details of a database.

User mapping 460 provides a mechanism for associating user entities in enterprise applications with one common entity that is authenticated by authentication service 455.

Notification service 465 allows other modules to send notifications in the form of emails. For example, rule engine service 470 uses service 465 to notify email recipients of discovered violations. As another example, approval service 415 uses service 465 to steer requests as part of a workflow.

Roles service 475 is used for creating and editing roles, creating and editing authorizations and adding them to roles and for assigning roles to users.

Auditing service 480 is used by other modules for auditing operations performed by users, for example, the assignment of roles, creation of user accounts and executing an analysis. Information in the audit log provides irrefutable evidence about ‘who did what’.

Adapter 140 of system 100 extracts data from an enterprise application. Extraction is done so as to minimize the impact on the performance of the enterprise application. Adapter 140 engages with the enterprise application for a minimal time, extracts the data and persists it in database 150. Further steps of analysis and reporting do not require a live connection with the enterprise application since they are performed outside the enterprise application. Performing analysis and reporting outside also makes it possible to define controls across enterprise applications.

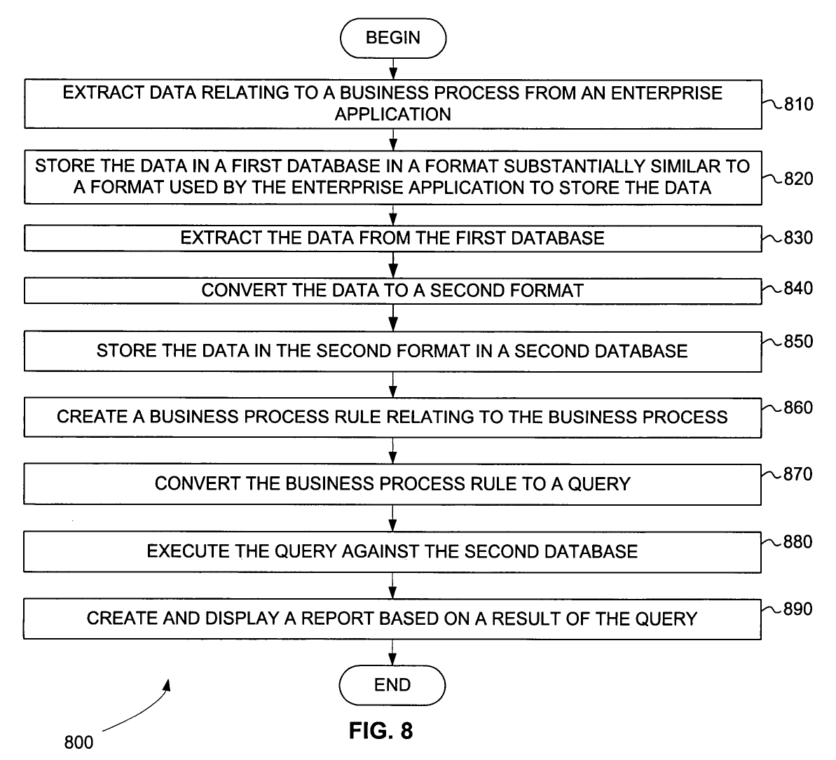

FIG. 8 is a flowchart showing a method 800 for monitoring the business processes of enterprise applications, in accordance with an embodiment of the present invention.

In step 810 of method 800, data relating to the business process is extracted from the enterprise application. The solutions permit an adapter for a business process to publish the schema of its business entities, for example, purchase orders, vendors and materials. The solution employs a unique mechanism to dynamically discover published schema and schema changes. The dynamically discovered business entities are then exposed to the user of the solution so that rules can be defined over them (in step 850). This provides extensibility and flexibility.

In step 820, the data is stored in a first database in a format substantially similar to a format used by the enterprise application to store the data.

In step 830, the data is extracted from the first database.

In step 840, the data is converted to a second format.

Alternatively, the system permits other legacy applications to export their extracted data in a pre-specified format (the second format) so that it can be imported into the system in step 850.

In step 850, the data is stored in the second format in a second database.

In step 860, a business process rule relating to the business process is created.

In step 870, the business process rule is converted to a query. Queries are targeted either at the second database or directly at the internal database of an enterprise application. This permits the elimination of the extraction step 810 where desirable.

In step 880, the query is executed against the second database. Alternatively, instead of the query of steps 870 and 880, an algorithm could be executed as described above.

In step 890, a report is created and displayed based on a result of the query.

Generated reports permit the user to remediate the causes behind a discovered violation, thus completing the chain of events: data extraction→analysis→remediation.

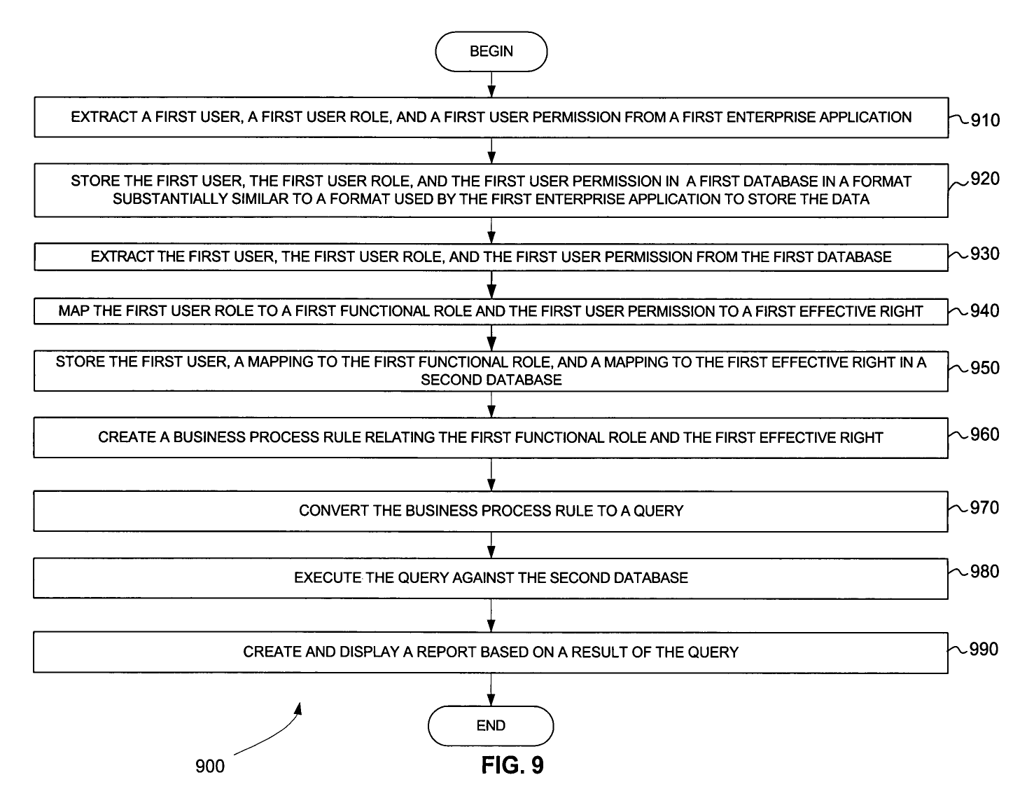

FIG. 9 is a flowchart showing a method 900 for monitoring user activity of enterprise applications, in accordance with an embodiment of the present invention.

In step 910 of method 900, a first user, a first user role, and a first user permission are extracted from a first enterprise application.

In step 920, the first user, the first user role, and the first user permission are stored in a first database in a format substantially similar to a format used by the first enterprise application to store the data.

In step 930, the first user, the first user role, and the first user permission are extracted from the first database.

In step 940, the first user role is mapped to a first functional role and the first user permission is mapped to a first effective right.

In step 950, the first user, a first role mapping to the first functional role, and a first effective right mapping to the first effective right are stored to a second database.

In step 960, a business process rule is created relating the first functional role and the first effective right.

In step 970, the business process rule is converted to a query.

In step 980, the query is executed against the second database. Alternatively, instead of the query of steps 970 and 980, an algorithm could be executed as described above.

In step 990, a report is created and displayed based on a result of the query.

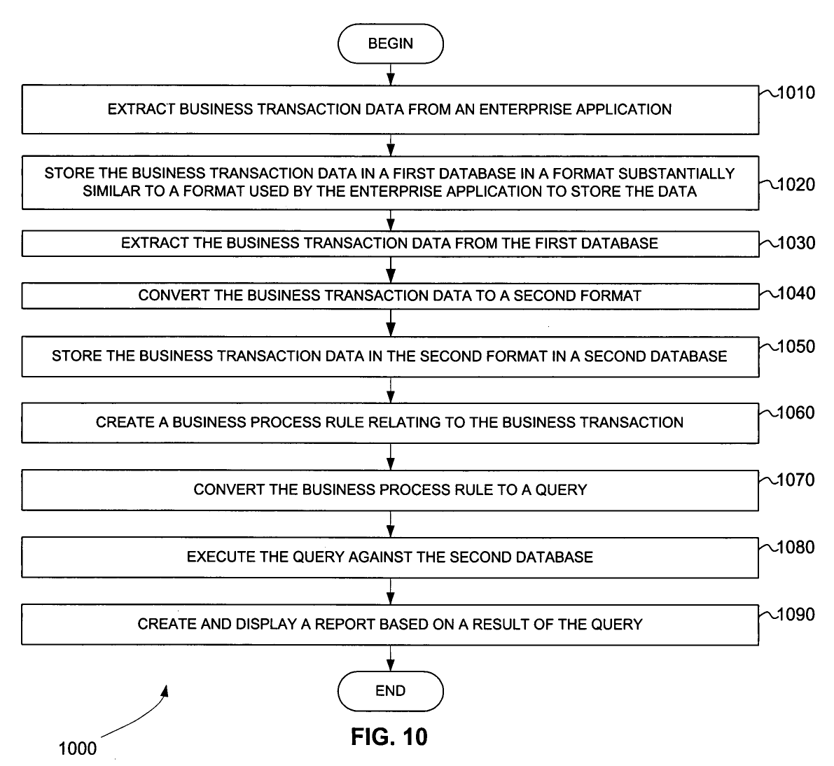

FIG. 10 is a flowchart showing a method 1000 for monitoring business transactions of enterprise applications, in accordance with an embodiment of the present invention.

In step 1010 of method 1000, business transaction data is extracted from an enterprise application.

In step 1020, the business transaction data is stored in a first database in a format substantially similar to a format used by the enterprise application to store the data.

In step 1030, the business transaction data is extracted from the first database.

In step 1040, the business transaction data is converted to a second format.

In step 1050, the business transaction data is stored in the second format to a second database.

In step 1060, a business process rule is created relating to the business transaction.

In step 1070, the business process rule is converted to a query.

In step 1080, the query is executed against the second database. Alternatively, instead of the query of steps 1070 and 1080, an algorithm could be executed as described above.

In step 1090, a report is created and displayed based on a result of the query.

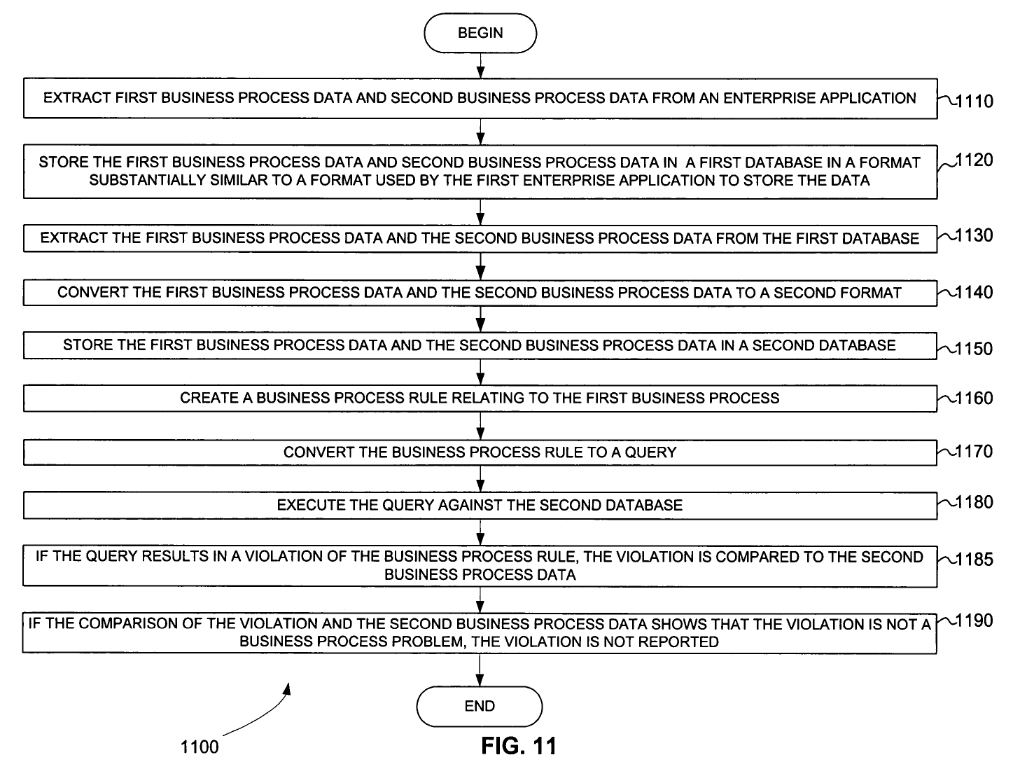

FIG. 11 is a flowchart showing a method 1100 for detecting false positives when monitoring a first business process and a second business process of an enterprise application.

In step 1110 of method 1100, first business process data and second business process data are extracted from the enterprise application.

In step 1120, the first business process data and the second business process data are stored in a first database in a format substantially similar to a format used by the enterprise application to store the data.

In step 1130, the first business process data and the second business process data are extracted from the first database.

In step 1140, the first business process data and the second business process data are converted to a second format.

In step 1150, the first business process data and the second business process data in the second format are stored to a second database.

In step 1160, a business process rule is created relating to the first business process data.

In step 1170, the business process rule is converted to a query.

In step 1180, the query is executed against the second database. Alternatively, instead of the query of steps 1170 and 1180, an algorithm could be executed as described above.

In step 1185, if the query results in a violation of the business process rule, the violation is compared to the second business process data.

In step 1190, if the comparison of the violation and the second business process data shows that the violation is not a business process problem, the violation is not reported.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM (“CD-ROM”) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Systems and methods in accordance with an embodiment of the present invention disclosed herein can be used to continuously monitor a business process of an enterprise application. Converting extracted enterprise application dependent data to a generic data format allows the system to be used with two or more enterprise applications with little modification.

In the foregoing detailed description, systems and methods in accordance with embodiments of the present invention have been described with reference to specific exemplary embodiments. Accordingly, the present specification and figures are to be regarded as illustrative rather than restrictive. The scope of the invention is to be further understood by the numbered examples appended hereto, and by their equivalents.

What is claimed is:

1. A system for a monitoring a business process of an enterprise application, comprising:
an adapter component, wherein the adapter component extracts data relating to the business process from the enterprise application;
an adapter database, wherein the adapter component stores the data in the adapter database in a format substantially similar to a format used by the enterprise application to store the data;
a core services component, wherein the core services component communicates with the adapter component, schedules data extraction by the adapter component from the enterprise application, and receives the data in a second format from the adapter component that is extracted from the adapter database by the adapter component and converted to the second format by the core services component;
a core services database, wherein the core services component stores the data in the second format in the core services database, wherein the core services component creates a business process rule relating to the business process, wherein the core services component executes the business process rule against the core services database, and wherein the core services component creates a report based on a result of the execution; and
a user interface, wherein the user interface allows a user to control creation of the business process rule by the core services component and wherein the user interface allows a user to monitor the business process by displaying the report created by the core services component.

2. The system of claim 1, wherein the enterprise application comprises one or more of an enterprise resource planning program, a supply chain management program, and a customer relationship management program.

3. The system of claim 1, wherein the adapter component extracts data relating to the business process from the enterprise application, the adapter component stores the data in the adapter database, the core services component communicates with the adapter component, the core services component receives the data in a second format from the adapter component, the core services component stores the data in the second format in the core services database, and the core services component executes the business process rule against the core services database at periodic intervals in order to continuously monitor the enterprise application.

4. The system of claim 1, wherein the business process is one or more of user activity, business transactions, and configuration of the enterprise application.

5. The system of claim 1, wherein the core services component comprises one or more of a users service, reports service, approval service, utilities service, security service, licensing service, extraction service, logging service, configuration service, database service, authentication service, user mapping service, notification service, rules engine service, roles service, and auditing service.

6. The system of claim 1, further comprising a second adaptor that accepts second data in a pre-specified format from a second enterprise application and stores the second data in the core services database.

7. The system of claim 1, wherein the user interface allows the user to control creation of the business process rule by entering the business process rule in a descriptive language.

8. A method for monitoring a business process of an enterprise application, comprising:
extracting data relating to the business process from the enterprise application;
storing the data in a first database in a format substantially similar to a format used by the enterprise application to store the data;
extracting the data from the first database;
converting the data to a second format;
storing the data in the second format to a second database;
creating a business process rule relating to the business process;
executing the business process rule against the second database; and
creating and displaying a report based on a result of the execution.

9. The method of claim 8, wherein the enterprise application comprises one or more of an enterprise resource planning program, a supply chain management program, and a customer relationship management program.

10. The method of claim 8, wherein extracting the data from the first database, converting the data to a second format, storing the data in the second format to a second database, and executing the business process rule against the second database occur at periodic intervals in order to continuously monitor the enterprise application.

11. The method of claim 8, wherein the business process is one or more of user activity, business transactions, and configuration of the enterprise application.

12. The method of claim 8, further comprising accepting second data in the second format from a second enterprise application and storing the second data in the second database.

13. The system of claim 8, wherein creating a business process rule relating to the business process comprises entering the business process rule in a descriptive language.

14. A method for monitoring user activity of enterprise applications, comprising:
extracting a first user, a first user role, and a first user permission from a first enterprise application;
storing the first user, the first user role, and the first user permission in a first database in a format substantially similar to a format used by the first enterprise application to store the data;
extracting the first user, the first user role, and the first user permission from the first database;
mapping the first user role to a first functional role and the first user permission to a first effective right;
storing the first user, a first role mapping to the first functional role, and a first effective right mapping to the first effective right to a second database;
creating a business process rule relating the first functional role and the first effective right;
executing the business process rule against the second database; and
creating and displaying a report based on a result of the execution.

15. The method of claim 14, further comprising displaying in the report a role violation within the first application for the first user if the business process rule defines the first effective right as too much authority for the first functional role.

16. The method of claim 14, further comprising
extracting a second user, a second user role, and a second user permission from a second enterprise application;
storing the second user, the second user role, and the second user permission in the first database in a format substantially similar to a format used by the second enterprise application to store the data;
extracting the second user, the second user role, and the second user permission from the first database;
mapping the second user role to a second functional role and the second user permission to a second effective right;
storing the second user, a second role mapping to the second functional role, and a second effective right mapping to the second effective right to the second database;
creating a second business process rule relating the second user and second functional role;
executing the second business process rule against the second database; and
creating and displaying a report based on a result of the execution of the second business process rule.

17. The method of claim 16, further comprising displaying in the report a role violation between the first application and the second application if the first user and the second user are a same user and the first functional role and the second functional role are different functional roles if the business process rule defines the second user as having only the second functional role.

18. A method for monitoring business transactions of enterprise applications, comprising:
extracting business transaction data from an enterprise application;
storing the business transaction data in a first database in a format substantially similar to a format used by the enterprise application to store the data;
extracting the business transaction data from the first database;
converting the business transaction data to a second format;
storing the business transaction data in the second format to a second database;
creating a business process rule relating to the business transaction;
executing the business process rule against the second database; and
creating and displaying a report based on a result of the execution.

19. The method of claim 18, wherein the business transaction comprises one of a purchase, a sale, a movement of a good, an acceptance of a good, a rejection of a good, a manufacture of a good, a creation of a business entity, a deletion of a business entity, and a modification of a business entity.

20. The method of claim 19, wherein a business entity comprises one of a user, a vendor, a customer, and a material.

21. The method of claim 18, wherein the business process rule comprises one of monitoring after execution of a sensitive transaction, monitoring for execution of sensitive transactions by individuals outside a specific location, monitoring for execution of sensitive transactions by individuals outside a specific time frame, monitoring for trends on sensitive transactions, and monitoring for an exception condition around transactions.

22. The method of claim 21, wherein the sensitive transaction comprises one of a financial transaction, a procurement transaction, an order entry transaction, and a supply chain transaction.

23. The method of claim 21, wherein the exception condition comprises one of a pricing discount, a purchase order, a shipment received, and a product return.

24. The method of claim 18, wherein executing the business process rule against the second database comprises converting the business process rule to a query and executing the query against the second database.

25. The method of claim 18, wherein executing the business process rule against the second database comprises converting the business process rules to parameters for rule specific algorithms and executing the algorithms.

26. A method for detecting false positives when monitoring a first business process and a second business process of an enterprise application, comprising:
extracting first business process data and second business process data from the enterprise application;
storing the first business process data and the second business process data in a first database in a format substantially similar to a format used by the enterprise application to store the data;
extracting the first business process data and the second business process data from the first database;
converting the first business process data and the second business process data to a second format;
storing the first business process data and the second business process data in the second format to a second database;
creating a business process rule relating to the first business process data;
converting the business process rule to a query;
executing the query against the second database;
if the query results in a violation of the business process rule, comparing the violation to the second business process data; and
if the comparing the violation to the second business process data shows that the violation is not a business process problem, not reporting the violation.

27. The method of claim 26, wherein the first business process comprises user activity and the second business process comprises one of business transactions and configuration of the enterprise application.

28. The method of claim 26, wherein the first business process comprises business transactions and the second business process comprises one of user activity and configuration of the enterprise application.

29. The method of claim 26, wherein the first business process comprises configuration of the enterprise application and the second business process comprises one of user activity and business transactions.
